(19) United States
(12) Patent Application Publication
(10) Pub. No.: US 2003/0012572 A1
(43) Pub. Date: Jan. 16, 2003

(54) Shipping and storage container for a camera crane

(75) Inventor: Leonard T. Chapman, North Hollywood, CA (US)

Correspondence Address: PERKINS COIE LLP, POST OFFICE BOX 1208, SEATTLE, WA, 98111-1208, US

(73) Assignee: Chapman/Leonard Studio Equipment

(21) Appl. No.: 10/205,053

(22) Filed: Jul. 25, 2002

Related U.S. Application Data
(63) Continuation-in-part of application No. 09/864,782, filed on May 24, 2001.
Application No. 09/864,782 is a continuation-in-part of application No. 09/616,587, filed on Jul. 14, 2000, now Pat. No. 6,450,706.
Application No. 09/616,587 is a continuation-in-part of application No. 09/584,561, filed on May 31, 2000, now abandoned.

(51) Int. Cl. G03B 17/00

(52) U.S. Cl. 396/428

(57) ABSTRACT

A shipping container or crate for a camera crane has a base including a cutout. Sidewalls of the crate have platforms for holding front and rear sections of the boom arm of the crane. The post section of the crane is suspended within the crate. The cutout allows a camera dolly to move directly underneath the crane arm, to lift the crane arm up and out of the crate. The need to lift the crane arm by hand is avoided.

This Application is a continuation-in-part of U.S. patent application Ser. No. 09/864,782, filed May 24, 2001, and now pending, which is a Continuation-In-Part of U.S. patent application Ser. No. 09/616,587, filed Jul. 14, 2000, and now pending, which is a Continuation-In-Part of U.S. patent application Ser. No. 09/584,561, filed May 31, 2000, now abandoned. These applications are incorporated herein by reference.

### BACKGROUND OF THE INVENTION

Camera cranes are often used in the production of motion pictures, as well as in television and video productions. The camera crane provides a stable platform for supporting and maneuvering the camera. The camera crane also provides extended height or reach useful for positioning the camera at high or low camera lens angles, or for positioning the camera in an otherwise difficult to reach position.

Camera cranes typically have a boom arm which may be mounted on a fixed support, such as a tri-pod. However, more often, the camera crane is mounted on a mobile platform, such as a camera dolly or mobile base. A fully assembled camera crane can exceed 20 or more feet in length, and weigh several hundred pounds, making storage and shipment of the assembled crane difficult. For transportation and storage, the camera crane may be provided in sections or major components, which can be separately stored and shipped, allowing for smaller and lighter shipping containers. In addition to the engineering challenges associated with storing or shipping a camera crane, or assembly of camera crane sections, can be difficult, due to the size and weight of the sections.

Accordingly, there is a need for an improved camera crane storage and/or shipping container. There is also a need for such a container which better facilitates assembly of camera crane sections, upon arrival at a filming location.

### SUMMARY OF THE INVENTION

In a first aspect of the invention, a shipping crate or container for a camera crane has a base including a cut out. First and second side walls are attached preferably adjacent opposite ends of the base. A first platform is supported on the first side wall, while a second platform is supported on the second side wall. The front of the container is open. The cut out extends into the base, to allow a camera dolly arm to be positioned within the container, to lift a crane arm section up and off of the container. As a result, the camera crane arm section can be quickly and easily attached to the camera dolly. As the camera dolly lifts the crane arm section out of the container, the time and effort required for manual lifting of the crane arm section, by hand, is avoided. The camera crane arm section can accordingly be more quickly and easily set up and assembled into a full camera crane, at a destination filming location.

In a second aspect, compartments are provided within the container for holding camera crane and leveling rod arm extension sections.

In a third aspect of the invention, the container includes a compartment or location for holding a track section of a crane arm.

In a fourth aspect, in a method for shipping a camera crane arm section, a post section of the camera crane arm section is suspended between side walls of a crate, and over a cut out in a base of the crate. At the destination filming location, a camera dolly is maneuvered so that a lift arm of the camera dolly is brought up vertically into contact with the post section. The crane arm section is then lifted up and out of the crate, without manual lifting.

Other objects, features and advantages will appear hereinafter. The invention resides as well in subcombinations of the features and methods described.

### BRIEF DESCRIPTION OF THE DRAWINGS

In the drawings, wherein the same reference number indicates the same element, in each of the views:

FIG. 1 is a perspective view of a camera crane in use supporting a camera, on a camera dolly.

FIG. 2 is a front perspective view of the camera crane arm section shown in FIG. 1, positioned on the shipping or storage crate or container.

FIG. 3 is a perspective view showing a camera dolly moved into the container shown in FIG. 2, in preparation for lifting the crane arm section up and out of the crate.

FIG. 4 is a perspective view of the crate shown in FIGS. 2 and 3.

FIG. 5 is an elevated perspective view of the crate shown in FIG. 4.

FIG. 6 is a plan view of the crate shown in FIGS. 2-5.

FIG. 7 is a side elevation view of the crate shown in FIGS. 2-5.

### DETAILED DESCRIPTION OF THE DRAWINGS

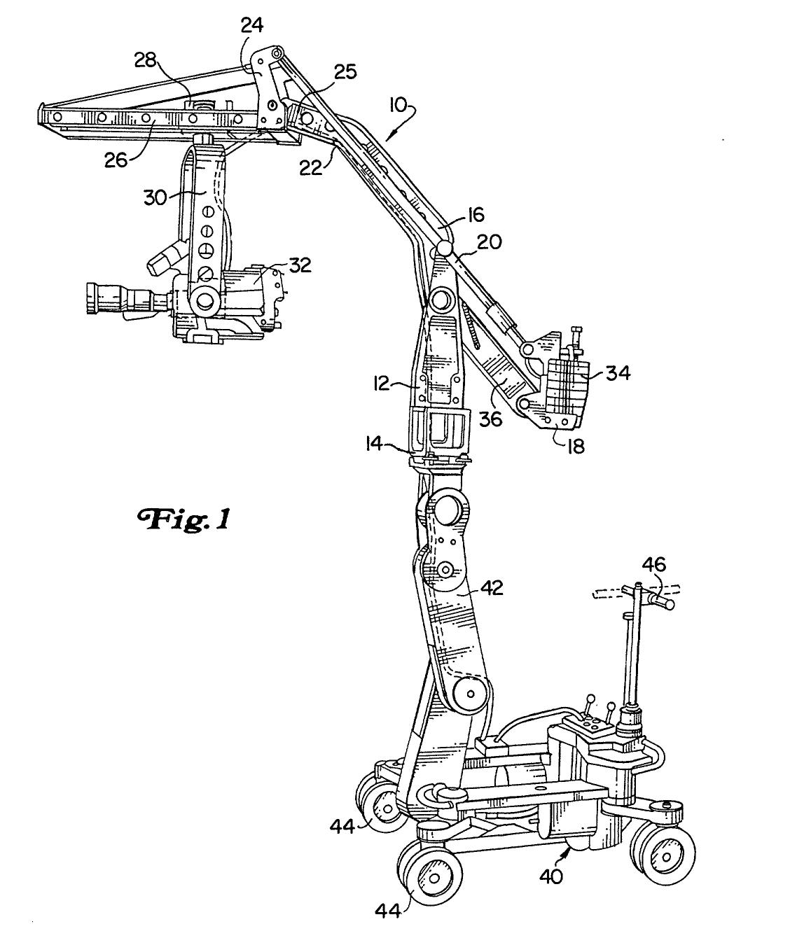

Turning now in detail to the drawings, as shown in FIG. 1, a camera crane 10 has a post section 12 supported on a leveling head 14. The crane arm 10 includes a boom arm 16 pivotably attached to the post section 12. A counter weight platform or bucket 18 is pivotably attached to a rear section 36 of the boom arm 16. In use, counter weights 34 are provided on the counter weight platform 18, to place the crane arm 10 into a balanced condition.

A front frame 24 is pivotably attached to a front section 25 of the boom arm 16. Leveling rods 20 extend from a pivot connection on the front frame to a pivot connection on the counter weight platform 18. A track section 26 is attached to the front crane 24. A camera frame 30 supporting a camera 32 is rotatably attached to a track head 28, which rolls or slides along the track section 26.

The entire crane arm 10 is supported by a camera dolly 40. The dolly 40 has an arm 42 which can be hydraulically raised and lowered. The leveling head, if used, is attached to the arm 42 of the dolly 40. Alternatively, the post section 12 may be attached directly to the arm 42 of the dolly 40. The front wheels 44 of the dolly 40, and optionally the rear wheels as well, are steered, preferably among multiple steering modes, via a steering bar 46. To extend the length of the boom arm 16, an arm extension section 50 and leveling rod extensions 52 may be used, as described in U.S. patent application Ser. No. 09/840,625, incorporated herein by reference.

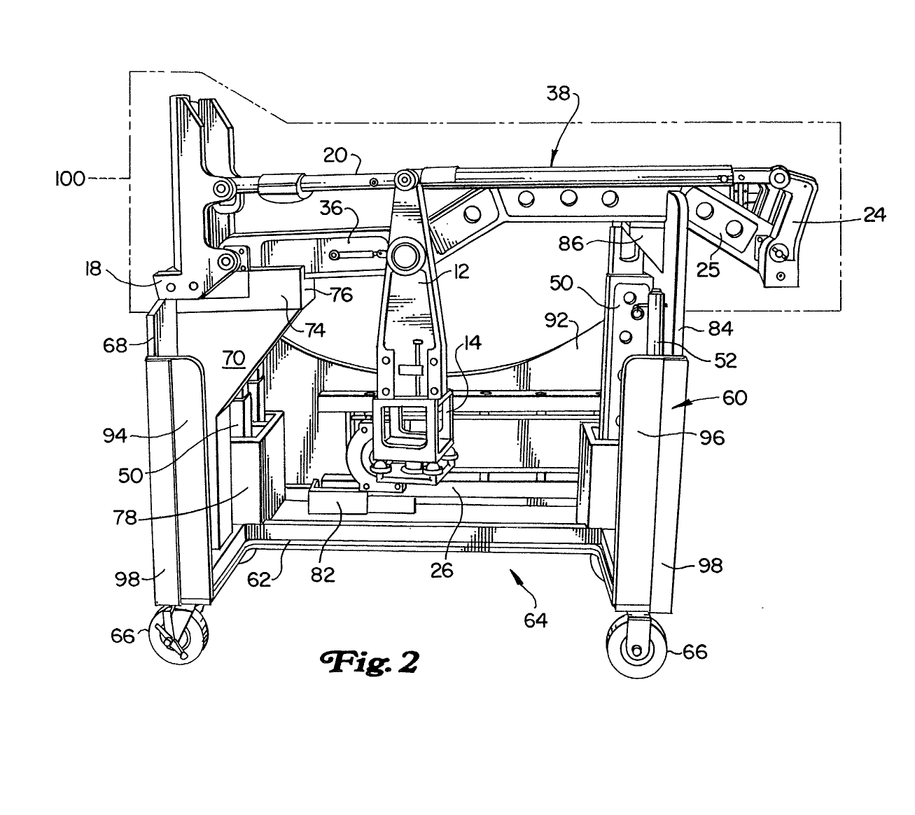

Turning to FIG. 2, for shipping or storage, components of the crane on 10 are separated. Specifically, the camera frame 30 and track section 26 are removed from the main section 38, with the main section 38 including the boom arm 16, the counter weight platform 18, the leveling rods 20, the post section 12, the front frame 24, and optionally the leveling head 14, if used.

As shown in FIG. 2, for shipping or storage, the main section 38 is supported on a shipping or storage crate, container or cart 60.

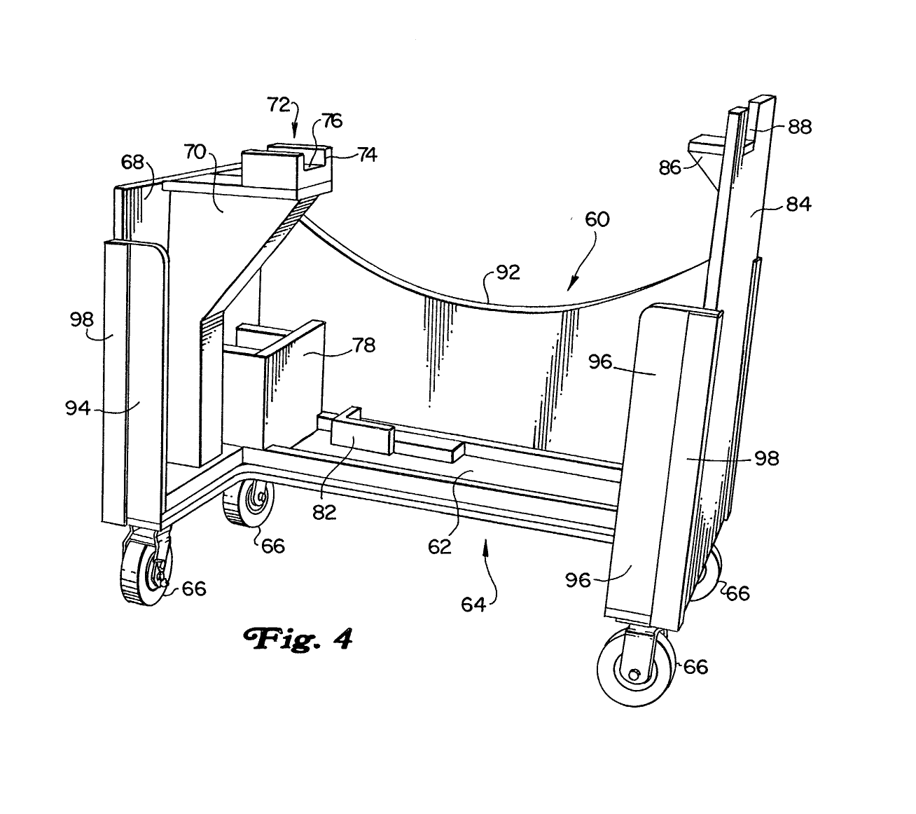

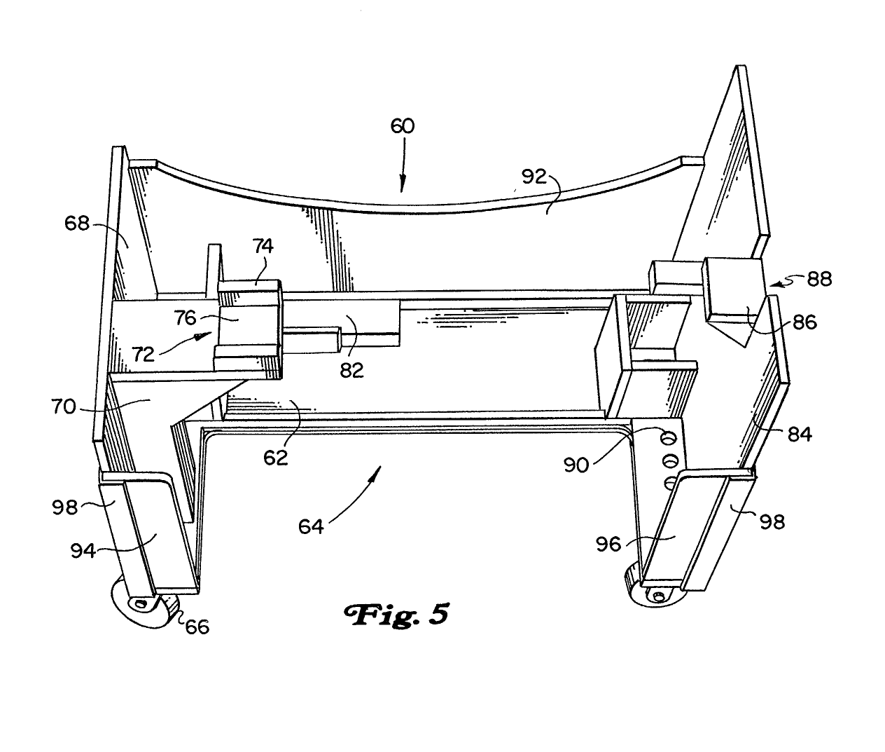

Turning to FIGS. 4-7, the crate 60 has a base 62 including a cutout 64. The width of the cutout 64 is preferably at least 20, 30, 40 or 50% of the width of the base 62. Wheels 66 are attached to the underside of the base 62. The wheels 66 at the first or left side of the crate 60 are preferably caster wheels. One or more of the four wheels 66 may include a brake.

A first or left side wall 68 is attached to the base 62 and to a rear wall 92. Similarly, a second or right side wall 84 is attached to the base and to the back wall 92. The side walls 68 and 84 form the opposite sides or ends of the crate 60. A first gusset platform 70 on the side wall 68 extends inwardly (towards the sidewall 84) and includes a center boss 76 having side flanges 74 forming an arm cup 72. The arm cup 72 is adapted to support the rear section 36 of the boom arm 16.

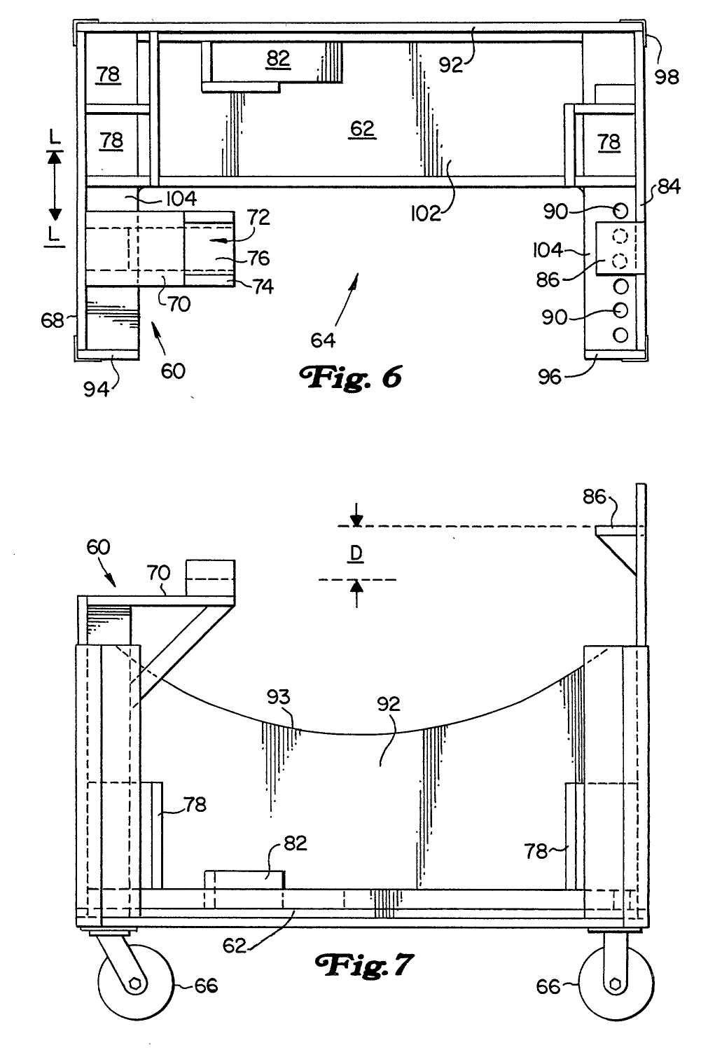

A second gusset platform 86 extends inwardly from the right side wall 84. A cutout 88 is provided in the second sidewall 84 above the second gusset platform 86. As shown in FIG. 6, the platforms 70 and 86 are longitudinally aligned with each other (in the direction L-L). As shown in FIG. 7, the second platform 86 is vertically above, or at a higher elevation than the platform 70 or the arm cup 72, by dimension capital D. As further shown in FIG. 7, the rear wall 62 preferably has a circumferential or curved upper edge 93.

Compartments 78 are provided on the base 62, for holding arm extension sections 50. Similarly, leveling rod extension holders or compartments 90 are provided on the base 62 along the side wall 84, for holding leveling rod extension sections 52. A track section holder or compartment 82 on the base 62 adjacent to the backwalls 92 is provided for holding the track section 26.

First and second front wall panels 94 and 96 extend inwardly from the first and second side walls 68 and 84. However, the front wall panels 94 and 96 extend inwardly only a short distance, with the cutout 64 in the base 62 occupying at least 60, 70, 80 or 90 percent of the length of the base 62. Consequently, as shown in FIG. 6, the base can be described as having an elongated rectangular main part 102, with rectangular side section or legs 104 at opposite ends.

In the preferred embodiment, the base 62, back wall 92, side walls 68 and 84, platforms 70 and 86, as well as the compartments 78 and 90 are made of plywood, optionally covered with felt, carpeting, vinyl, or other covering material. Metal corner shields 98 are optionally provided at the corners of the crate 60. As shown in FIG. 2, a crate cover or upper section 100 may be provided to more fully enclose the main section 38 during storage or shipping.

In use, the main section 38 is placed onto the crate 60, as shown in FIG. 2. Arm extension sections 50, if any, are loaded into the compartments 78. Similarly, leveling rod extension sections 52, if any, are loaded into the holders 90. The track section 26 is placed into the track section holder 82. The post section 12 is suspended within the crate 60. The main section 38 is secured to the crate 60 via straps, latches, or other attachment features. The cover 100, if used, is placed over the main section 38 and secured to the crate 60 with laches, straps or other attachments.

As shown in FIG. 2, the crate 60 includes all components of the crane arm 10, except for the counterweights 34, which are separately shipped and stored. The loaded crate 60 is moved into a vehicle, such as a truck or aircraft, and shipped to the destination location.

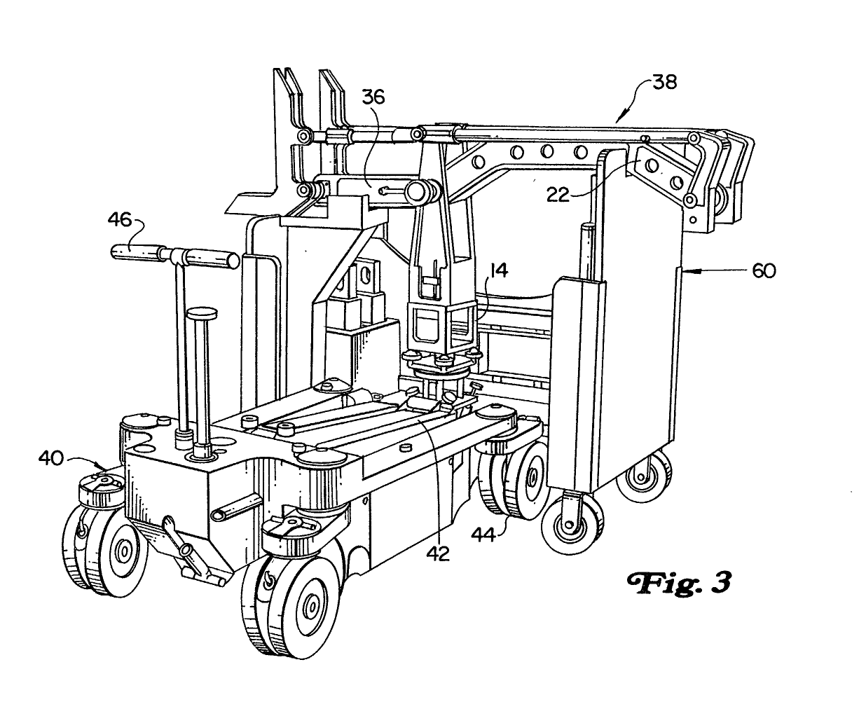

Referring to FIG. 3, upon arrival, the cover 100 (if any) is removed. The straps, laches or other attaching devices securing the main section 38 to the crate 60 are released. A camera dolly 40 (separately transported to the location) is maneuvered into position with the arm 42 of the dolly 40 underneath the post section 12 of the crane arm 10. As shown in FIG. 3, the front wheels 44 and the arm 42 of the dolly 40 are positioned within the cutout 64. The cutout 64 provides clearance to allow the dolly 40 to maneuver into position under the suspended post section 12. The arm 42 of the dolly 40 is raised (typically using a hydraulic system in the dolly 40) into contact with the post section 12, or the leveling head 14, if used. The post section 12 is secured onto the arm 42 via one or more fasteners. The arm 42 is then further raised, lifting the main section 38 up and off of the crate 60. The dolly 40 is then backed away from the crate, along with the main section 38 of the crane. The arm 42 is lowered and the track section 26, camera frame 30 and camera 32 are installed. The boom arm 16 is balanced via counterweights 34 provided in a separate crate or shipping container. The crane is then ready for use.

As the main section 38 typically weighs over 100 pounds, and is over 8 feet long, lifting and maneuvering the main section 38 by hand requires at least 2 people. On the other hand, since the crate 60 allows the main section 38 to be lifted directly by the dolly 40, shipping and assembly of the crane arm 10 is simplified, and requires only one person.

Thus, a novel shipping or storage cart or crate has been shown and described. Various changes and substitutions may of course be made, without departing from the spirit and scope of the invention. The invention, therefore, should not be limited, except to the following claims, and their equivalents.

1. A camera crane shipping container, comprising
a base having a cutout;
a first platform adjacent a first side wall attached to the base; and
a second platform adjacent a second side wall attached to the base.

2. The container of claim 1 wherein the first platform is longitudinally aligned with the second platform.

3. The container of claim 2 wherein the second platform is positioned at a vertical position higher than the first platform.

4. The container of claim 1 wherein the cutout extends substantially from the first side wall to the second side wall.

5. The container of claim 1 wherein the cutout extends over at least 75% of the length of the container.

6. The container of claim 1 wherein the cutout extends over at least 40% of the width of container.

7. The container of claim 1 wherein the first and second platforms are at least 40 inches above the ground.

8. The container of claim 1 further comprising one or more compartments on the base for holding a crane boom arm section.

9. The container of claim 1 further comprising one or more compartments on the base for holding a crane leveling rod extension section.

10. The container of claim 1 further comprising a back wall attached to the base and to the first and second side walls, with the container having an open front.

11. The container of claim 1 with the first platform on a first gusset section attached to the first wall.

12. The container of claim 11 with the second platform on a second gusset section attached to the second wall.

13. The container of claim 1 further comprising a crane arm track section holder on the base, for holding a crane arm track section.

14. The container of claim 1 wherein the first and second platforms are adapted to support first and second ends of a crane arm section, with a post section of the crane arm suspended within the container.

15. The container of claim 1 further comprising wheels attached to the base.

16. The container of claim 1 wherein the base is rectangular.

17. A crate for camera crane arm, comprising:
a base;
a first sidewall attached to a first end of the base, with first sidewall having a first height and a first width;
a first support platform adjacent a top end of the first wall;
a second side wall attached to a second end of the base, with the second sidewall having a second height, greater than the first height, and having a second width, substantially equal to the first width;
a second support platform adjacent a top end of the second sidewall, with the second support vertically higher than the first support; and
with a cutout in the base having a width which is at least 35% of the width of the first side wall.

18. A method of shipping a camera crane arm section, comprising the steps of:
lowering the crane arm section onto a shipping crate;
supporting the crane arm section on the crate adjacent first and second ends of the crane arm section, while suspending a post section between the first and second ends, within the crate.
securing the crane arm section to the crate;
shipping the crate containing the crane arm;
releasing the crane arm section from the crate;
positioning an arm of a camera dolly under the post section; and
raising the arm of the camera dolly, to lift the crane arm section up and off of the crate.
